(19) United States
(12) Patent Application Publication
(10) Pub. No.: US 2022/0413641 A1
(43) Pub. Date: Dec. 29, 2022

(54) INSTRUCTION INPUT DEVICE

(71) Applicant: KABUSHIKI KAISHA TOKAI RIKA DENKI SEISAKUSHO, Aichi (JP)

(72) Inventors: Yoshinori TAKABAYASHI, Aichi (JP); Takao ARAYA, Aichi (JP)

(73) Assignee: KABUSHIKI KAISHA TOKAI RIKA DENKI SEISAKUSHO, Aichi (JP)

(21) Appl. No.: 17/773,701

(22) PCT Filed: Sep. 25, 2020
(86) PCT No.: PCT/JP2020/036266

§ 371 Date: May 2, 2022

(30) Foreign Application Priority Data
Nov. 8, 2019 (JP) 2019-203270

(51) Int. Cl. G06F 3/044; G06F 3/0362; G06F 3/041; G06F 3/16

(52) U.S. Cl. CPC G06F 3/044; G06F 3/0362; G06F 3/04164; G06F 3/16; G06F 2203/04108

(57) ABSTRACT

At least a part of a movable switch is placed on a detection surface that is capable of detecting a variation in electrostatic capacitance caused by an approach or contact of a user's finger. A knob is configured to be displaced relative to the detection surface in accordance with an operation of the finger. A first conductive portion is arranged at a position in the knob where is separated from the detection surface. A plurality of second conductive portions are arranged at positions in the knob where are closer to the detection surface than the first conductive portion. A conductive path electrically connects the first conductive portion and the second conductive portions.

### FIELD

The presently disclosed subject matter relates to an instruction input device at least a part of which is adapted to be placed on a detection surface that is capable of detecting a variation in electrostatic capacitance caused by an approach or contact of a user's body.

### BACKGROUND

Japanese Patent Publication No. 2019-018771A discloses an instruction input device that is based on an electrostatic capacitance detection system. The device accepts an instruction input of a user by detecting a variation in electrostatic capacitance caused by an approach or contact of the user's body.

### SUMMARY

### Technical Problem

It is demanded to improve the operability of the instruction input device that is based on the electrostatic capacitance detection system.

### Solution to Problem

In order to meet the demand described above, an illustrative aspect of the presently disclosed subject matter provides an instruction input device at least a part of which is adapted to be placed on a detection surface that is capable of detecting a variation in electrostatic capacitance caused by an approach or contact of a user's body, comprising:

a movable part configured to be displaced relative to the detection surface in accordance with an operation of a part of the user's body;

a first conductive portion arranged at a position in the movable part where is separated from the detection surface;

a plurality of second conductive portions arranged at positions in the movable part where are closer to the detection surface than the first conductive portion;

a conductive path electrically connecting the first conductive portion and the second conductive portions.

When the part of the user's body approaches or contacts the first conductive portion, the potential of the second conductive portions electrically connected to the first conductive portion via the conductive path varies from the initial state. When the movable part is displaced in this state, the second conductive portions are displaced with respect to the detection surface while maintaining the positional relationship therebetween. That is, a position in the detection surface where a variation in the electrostatic capacitance is detected moves. As a result, it is possible to cause the detection surface to recognize the displacement of the second conductive portions as an instruction input similar to the touch operation performed with the part of the user's body with respect to the detection surface.

According to such a configuration, it is possible to input an instruction to the instruction input device that is based on the electrostatic capacitance detection system through the instruction input device having the movable part that is superior in the intuitive operability. Accordingly, it is possible to improve the operability of the instruction input device that is based on the electrostatic capacitance detection system. In addition, since the displacement of the second conductive portions is detected as a movement of the point where the electrostatic capacitance in the detection surface varies, it is unnecessary to newly provide, on the side of the detection surface, a special configuration for detecting an instruction input with the movable switch part. In other words, it is possible to improve the operability of the instruction input device that is based on the electrostatic capacitance detection system even if it is a general-purpose device.

### BRIEF DESCRIPTION OF DRAWINGS

FIG. 1 illustrates a touch panel and a movable switch according to an embodiment.

FIG. 2 illustrates a functional configuration of the touch panel and the movable switch of FIG. 1.

FIG. 3 illustrates a vehicle in which the touch panel and the movable switch of FIG. 1 are to be installed.

FIG. 4 illustrates an appearance of the movable switch of FIG. 1.

FIG. 5 illustrates an appearance of the movable switch of FIG. 1.

FIG. 6 illustrates an internal configuration of another exemplary movable switch.

FIG. 7 illustrates a state that the movable switch of FIG. 6 is subjected to a push operation.

FIG. 8 illustrates another exemplary movable switch.

FIG. 9 illustrates another exemplary movable switch.

FIG. 10 illustrates another exemplary movable switch.

FIG. 11 illustrates a flow of processing to be executed by a control device of the touch panel.

FIG. 12 illustrates an exemplary operation of the touch panel of FIG. 11.

FIG. 13 illustrates another exemplary operation of the touch panel of FIG. 11.

FIG. 14 illustrates another exemplary operation of the touch panel of FIG. 11.

FIG. 15 illustrates a functional configuration of another exemplary movable switch.

FIG. 16 illustrates an operation of another exemplary movable switch.

### DESCRIPTION OF EMBODIMENTS

Examples of embodiments will be described in detail below with reference to the accompanying drawings. In each of the drawings used in the following description, the scale is appropriately changed in order to make each member have a recognizable size.

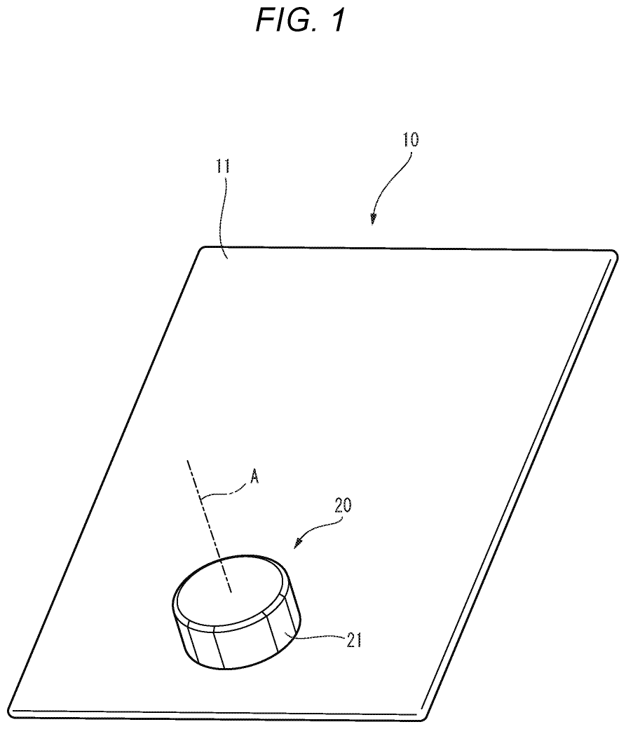

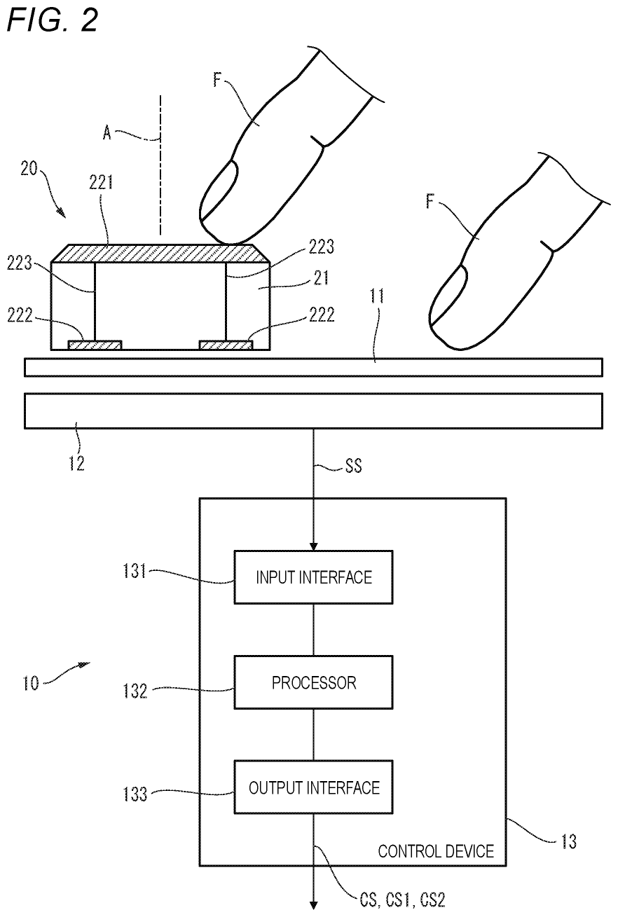

FIG. 1 illustrates an external appearance of a touch panel 10 according to an embodiment. FIG. 2 illustrates a functional configuration of the touch panel 10.

The touch panel 10 includes a detection surface 11. The detection surface 11 is configured to allow a part of a user's body (e.g., the finger F) to perform a touch operation. As used herein, the term “touch operation” means an operation involving an approach or contact of a part of a user's body with respect to the detection surface 11. The user can input a desired instruction to the touch panel 10 through the touch operation. The touch panel 10 is an example of a first instruction input device.

The touch panel 10 includes a touch sensor 12. The touch sensor 12 includes an electrode (not illustrated). The electrode is disposed so as to face the detection surface 11.

The touch sensor 12 includes an electrostatic capacitance detector (not illustrated). The electrostatic capacitance detector is configured to output a detection signal SS corresponding to the electrostatic capacitance between the detection surface 11 and the electrode. The detection signal SS may be an analog signal or a digital signal.

Specifically, the electrostatic capacitance detector includes a charging/discharging circuit. The charging/discharging circuit is electrically connected to the electrode. The charging/discharging circuit can perform a charging operation and a discharging operation. The charging/discharging circuit during the charging operation feeds current supplied from a power source (not illustrated) to the electrode. The charging/discharging circuit causes the electrode to emit current during the discharging operation. An electric field is generated around the detection surface 11 by the current supplied to the electrode. When the finger F of the user approaches this electric field, a pseudo capacitor is formed between the electrode and the finger F. As a result, the electrostatic capacitance between the electrode and the detection surface 11 is increased. As the electrostatic capacitance increases, the current emitted from the electrode during the discharging operation increases. The touch sensor 12 reflects the value of the current in the detection signal SS.

The touch panel 10 includes a control device 13. The control device 13 includes an input interface 131, a processor 132, and an output interface 133.

The input interface 131 receives the detection signal SS outputted from the touch sensor 12. In a case where the detection signal SS is an analog signal, the input interface 131 includes an appropriate conversion circuit including an A/D converter.

The processor 132 is configured to recognize what kind of touch operation is performed on the touch panel 10 based on the detection signal SS. For example, the detection signal SS may include information indicative of a position in the detection surface 11 where the finger F of the user approaches or contacts. The processor 132 can recognize what instruction is inputted to the touch panel 10 by acquiring the position indicated by the detection signal SS, the change with time of the position, the number of approaches or contacts, and the like.

The processor 132 is configured to generate a control signal CS for causing a controlled device to perform an operation corresponding to the instruction as recognized. The processor 132 is configured to output the generated control signal CS from the output interface 133 to the controlled device. The control signal CS may be an analog signal or a digital signal. In a case where the control signal CS is the analog signal, the output interface 133 includes an appropriate conversion circuit including a D/A converter. This description can be similarly applied to a first control signal CS1 and a second control signal CS2 described later.

As illustrated in FIGS. 1 and 2, a movable switch 20 is placed on the detection surface 11 of the touch panel 10. The movable switch 20 includes a knob 21. The knob 21 is configured to be rotatable about a rotation axis A in accordance with an operation performed with a part of a user's body (e.g., a finger F or a hand). In other words, the knob 21 is configured to be displaced relative to the detection surface 11 in accordance with an operation performed by a user. The user can input a desired instruction to the movable switch 20 by rotating the knob 21. The movable switch 20 is an example of a second instruction input device. The knob 21 is an example of a movable part.

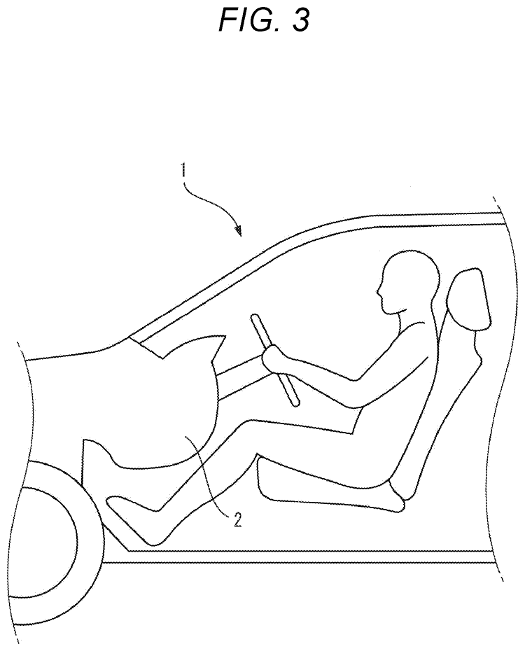

Such an assembly of the touch panel 10 and the movable switch 20 can be installed in a center cluster 2 of a vehicle 1 as illustrated in FIG. 3. The vehicle 1 is an example of a mobile entity. In this case, the user is an occupant of the vehicle 1.

In this case, the movable switch 20 can be used for adjusting a sound volume in an audio-visual equipment, selecting a song or a channel, adjusting a temperature or an air flow in an air conditioner, and the like. The touch panel 10 is adapted to be used for inputting an instruction to a controlled device for controlling an operation thereof through a touch operation. For example, the touch panel 10 can be used for performing detailed settings in the audio-visual equipment, an operation of a navigation device, and the like.

The detection surface 11 of the touch panel 10 may be at least a part of a surface of a display device capable of displaying an image. In this case, a graphic user interface (GUI) is provided through the detection surface 11. The image included in the GUI can be appropriately changed in accordance with an instruction that can be inputted to the controlled device.

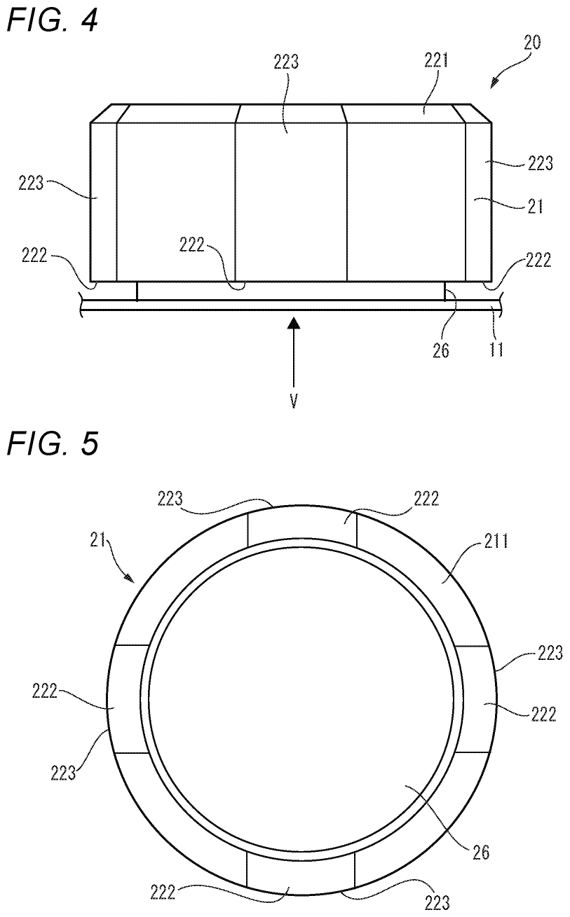

FIG. 4 illustrates an appearance of the movable switch 20 as viewed from a lateral side. FIG. 5 illustrates an appearance of the movable switch 20 as viewed from a direction along an arrow V in FIG. 4.

The movable switch 20 includes a first conductive portion 221. The first conductive portion 221 is formed of a material having electrical conductivity. The first conductive portion 221 is arranged at a position in the knob 21 where is separated from the detection surface 11 of the touch panel 10. In this example, the first conductive portion 221 extends along a peripheral edge of an upper end portion of the knob 21 having a cylindrical shape.

The movable switch 20 includes a plurality of second conductive portions 222. The second conductive portions 222 are formed of a material having electrical conductivity. The second conductive portions 222 are arranged at positions in the knob 21 where are closer to the detection surface 11 of the touch panel 10 than the first conductive portion 221. In this example, the second conductive portions 222 are arranged on a bottom surface 211 of the knob 21 so as to face the detection surface 11. In this example, the second conductive portions 222 face the detection surface 11 with a gap interposed therebetween.

The movable switch 20 includes a conductive path 223. The conductive path 223 is formed of a material having electrical conductivity. The conductive path 223 electrically connects the first conductive portion 221 and the second conductive portions 222.

As illustrated in FIG. 2, when the finger F of the user approaches or contacts the first conductive portion 221, the potential of the second conductive portions 222 electrically connected to the first conductive portion 221 via the conductive path 223 varies from the initial state. As a result, in a manner similar to the case where the finger F of the user approaches or contacts the detection surface 11 of the touch panel 10, the electrostatic capacitance between the electrode of the touch sensor 12 and the detection surface 11 varies.

When the knob 21 is rotated in this state, the second conductive portions 222 are displaced with respect to the detection surface 11 of the touch panel 10 while maintaining the positional relationship therebetween. That is, a position in the detection surface 11 where a variation in the electrostatic capacitance is detected moves. As a result, it is possible to cause the touch panel 10 to recognize the displacement of the second conductive portions 222 as an instruction input similar to the touch operation performed with the finger F of the user with respect to the detection surface 11. The control device 13 of the touch panel 10 recognizes the content of the input instruction based on the rotated direction and the rotated amount of the knob 21, and outputs a control signal CS corresponding to the instruction.

According to such a configuration, it is possible to input an instruction to the touch panel 10 that is based on the electrostatic capacitance detection system through the movable switch 20 having the knob 21 that is superior in the intuitive operability. Accordingly, it is possible to improve the operability of the touch panel 10 that is based on the electrostatic capacitance detection system. In addition, since the displacement of the second conductive portions 222 is detected just as a movement of the point where the electrostatic capacitance in the detection surface 11 of the touch panel 10 varies, it is unnecessary to newly provide, on the side of the touch panel 10, a special configuration for detecting an instruction input with the movable switch 20. In other words, even if a general-purpose touch panel is used as the touch panel 10, it is possible to improve the operability thereof.

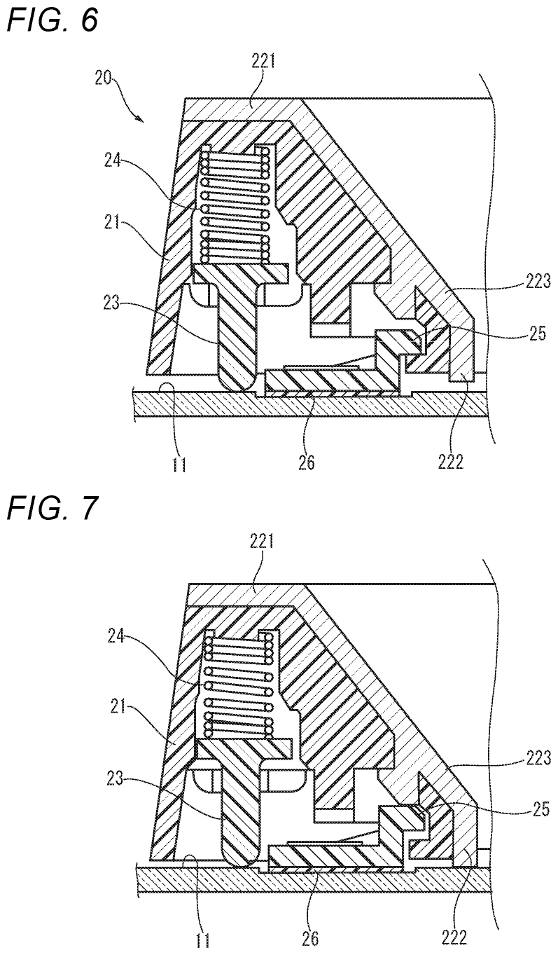

In addition to or in place of the configuration capable of performing the rotary operation as described above, the knob 21 may be configured to be capable of performing a push operation. FIG. 6 illustrates an internal configuration of another exemplary movable switch 20 having such a configuration. It is illustrated a cross section of a portion of a knob 21 having a cylindrical shape, the portion extending in a radial direction thereof from a center axis to an outer circumferential face.

The movable switch 20 according to the present example includes a support pin 23, a spring 24, and a stopper 25. A lower end of the support pin 23 contacts the detection surface 11 of the touch panel 10. The spring 24 is interposed between an upper end of the support pin 23 and the knob 21. The spring 24 biases the knob 21 in a direction away from the detection surface 11. The stopper 25 engages a part of the knob 21, thereby preventing the knob 21 from being separated from the detection surface 11. The initial position of the knob 21 is defined by the stopper 25.

In this example as well, the first conductive portion 221 is disposed at a position separated from the detection surface 11 of the knob 21. The second conductive portions 222 are disposed at positions in the knob 21 where are closer to the detection surface 11 than the first conductive portion 221. In FIG. 6, only one of the second conductive portions 222 is illustrated. Specifically, the first conductive portion 221 extends along a peripheral edge of the upper end portion of the knob 21. The second conductive portions 222 are disposed on a bottom surface 211 of the knob 21 so as to face the detection surface 11. When the knob 21 is in the initial position, the second conductive portions 222 face the detection surface 11 with a gap therebetween. In this example, the conductive path 223 extends inside the knob 21 to connect the first conductive portion 221 and the second conductive portions 222.

As illustrated in FIG. 7, when the knob 21 is pushed from above, the spring 24 is compressed, so that the knob 21 is displaced downward. As a result, the second conductive portions 222 contact the detection surface 11. As a result, in a manner similar to the case where the finger F of the user approaches or contacts the detection surface 11 of the touch panel 10, the electrostatic capacitance between the electrode of the touch sensor 12 and the detection surface 11 varies. That is, the displacement of the second conductive portions 222 caused by the push operation of the movable switch 20 can be recognized by the touch panel 10 as an instruction input similar to the touch operation performed with the finger F of the user on the detection surface 11. The control device 13 of the touch panel 10 recognizes the content of the input instruction based on the timing at which the knob 21 is pushed and the number of times the knob 21 is pushed, and outputs a control signal CS corresponding to the instruction.

As illustrated in FIGS. 4 to 7, the movable switch 20 may include a fixing part 26. The fixing part 26 fixes the movable switch 20 to the detection surface 11 of the touch panel 10 while allowing the displacement of the knob 21. The fixing part 26 can be realized by a double-sided tape or an adhesive.

As described above, an instruction input via the movable switch 20 is detected by the touch panel 10 as a movement of the point at which the electrostatic capacitance varies in accordance with the displacement of the second conductive portions 222. Accordingly, as described above, the movable switch 20 can be fixed to the detection surface 11 without changing the configuration of the touch panel 10.

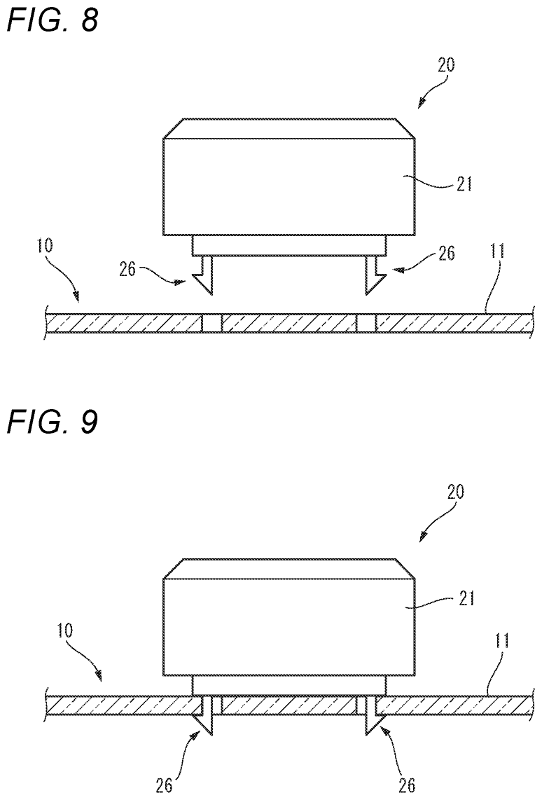

As illustrated in FIGS. 8 and 9, the fixing part 26 may also be realized by an engagement structure such as a snap fit. In this case, one of an engagement pawl and an engagement hole is provided in the movable switch 20, and the other is provided in the touch panel 10. In the illustrated example, the engagement pawl is provided on the movable switch 20, and the engagement hole is formed in the touch panel 10. The engagement between the engagement pawl and the engagement hole may be permanent or may be releasable. In the latter case, the movable switch 20 may be detachable from the detection surface 11 of the touch panel 10.

In order to make the movable switch 20 detachable from the detection surface 11, the engagement structure as illustrated in FIGS. 8 and 9 is not essential. For example, a weak adhesive layer sufficient to temporarily fix the movable switch 20 to the detection surface 11 may be provided at a portion of the movable switch 20 that contacts the detection surface 11.

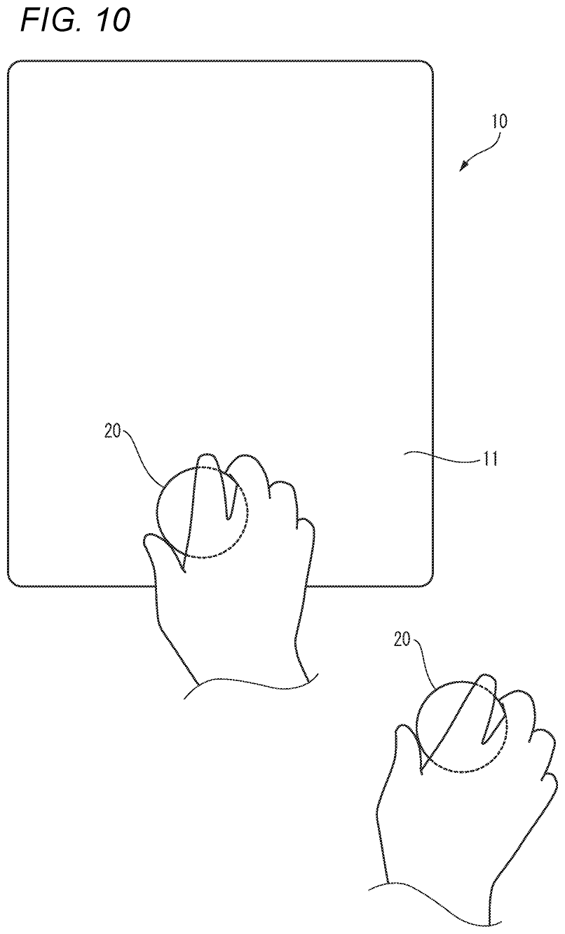

Alternatively, as illustrated in FIG. 10, the placement of the movable switch 20 on the detection surface 11 of the touch panel 10 may depend only on a holding force of a user's hand. In other words, the fixing part 26 is not essential. In this case as well, since the hand of the user contacting the first conductive portion 221 is detected as a variation in the electrostatic capacitance in the detection surface 11 through the second conductive portions 222, it is possible to input an instruction through the movable switch 20.

By enabling the movable switch 20 to be detached from the detection surface 11, the detection surface 11 can be entirely used to accept a touch operation performed by the user except when an instruction with the movable switch 20 is required. Particularly in a case where the detection surface 11 also serves as a screen of the display device, the GUI can be provided by utilizing the screen to the maximum extent.

In this example, even when the knob 21 is rotated, the second conductive portions 222 face the detection surface 11 of the touch panel 10 with a gap interposed therebetween.

According to such a configuration, since the second conductive portions 222 do not contact the detection surface 11 in a sliding manner, not only the rotary operation can be smoothly performed, but also the detection surface 11 can be prevented from being damaged. This advantage is particularly remarkable in a case where the movable switch 20 is attached to or detached from the detection surface 11.

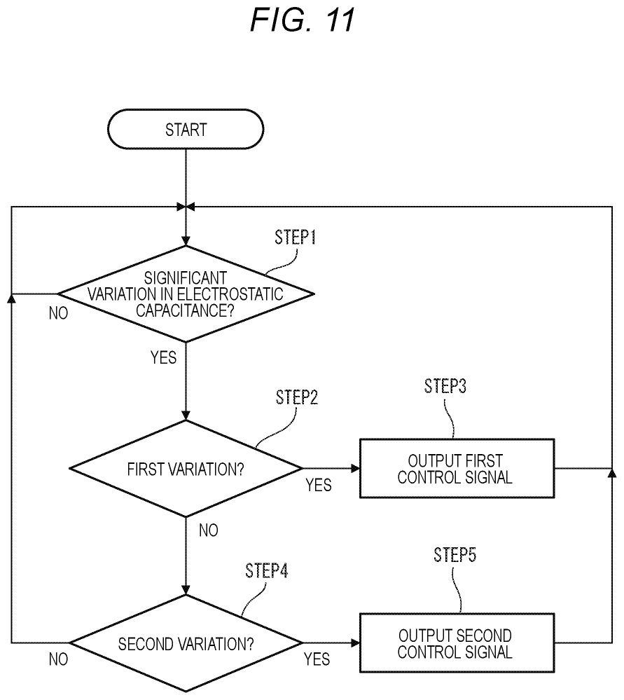

FIG. 11 illustrates an exemplary flow of processing to be executed by the control device 13 of the touch panel 10 in a case where the movable switch 20 is detachable from the detection surface 11 as described above.

The processor 132 determines whether a significant electrostatic capacitance variation is detected in the detection surface 11 (STEP1). Specifically, it is determined whether the magnitude of the electrostatic capacitance variation in the detection surface 11 indicated by the detection signal SS inputted to the input interface 131 exceeds a threshold value. The processing is repeated until it is determined that the magnitude of the electrostatic capacitance variation exceeds the threshold value (NO in STEP1).

When it is determined that the magnitude of the electrostatic capacitance variation exceeds the threshold value (YES in STEP1), the processor 132 determines whether the electrostatic capacitance variation is a first variation caused by an approach or contact of a part of a user's body with the detection surface 11 (STEP2). Specifically, when at least one of the conditions listed below is satisfied, the processor 132 determines that the first variation is detected.
The number of the point at which the approach or contact with the detection surface 11 is detected is single.
The number of the point at which the approach or contact with the detection surface 11 is detected is plural, and the mutual positional relationship between the points is not constant.
An area in which the contact with the detection surface 11 is detected is not constant.

When it is determined that the first variation is detected (YES in STEP2), the processor 132 outputs a first control signal CS1 from the output interface 133 (STEP3). The first control signal CS1 is a signal for causing the touch panel 10 to provide a first operation state. The first operation state is an operation state for accepting an input of a touch operation performed with a part of a user's body. After the first control signal CS1 is outputted, the processing returns to STEP1.

When it is determined that the detected electrostatic capacitance variation is not the first variation (NO in STEP2), the processor 132 determines whether the electrostatic capacitance variation is a second variation caused by the approach or contact of the second conductive portions 222 of the movable switch 20 with respect to the detection surface 11 (STEP4). Specifically, when at least one of the conditions listed below is satisfied, the processor 132 determines that the second variation is detected.
The number of the point at which the approach or contact with the detection surface 11 is detected is plural, and the mutual positional relationship between the points is constant.
An area in which the contact with the detection surface 11 is detected is constant.

When it is determined that the second variation is detected (YES in STEP4), the processor 132 outputs a second control signal CS2 from the output interface 133 (STEP5). The second control signal CS2 is a signal for causing the touch panel 10 to provide a second operation state. The second operation state is an operation state for accepting an instruction input with the movable switch 20. After the second control signal CS2 is outputted, the processing returns to STEP1.

When it is not determined that the second variation is detected (NO in STEP4), the processing returns to STEP1, and the detection of the electrostatic capacitance is performed again.

According to such a configuration, it is possible to normally use the entire detection surface 11 of the touch panel 10 to accept an instruction input based on a touch operation, and to switch the operation state of the touch panel 10 so as to cope with an instruction input with the movable switch 20 in response to the placement of the movable switch 20 on the detection surface 11. Accordingly, it is possible to improve the operability of the touch panel 10 that is based on the electrostatic capacitance detection system.

In a case where the detection surface 11 of the touch panel 10 also serves as a screen of the display device, the first operation state may include display of a first image by the display device. The second operating state may include a display of a second image different from the first image by the display device.

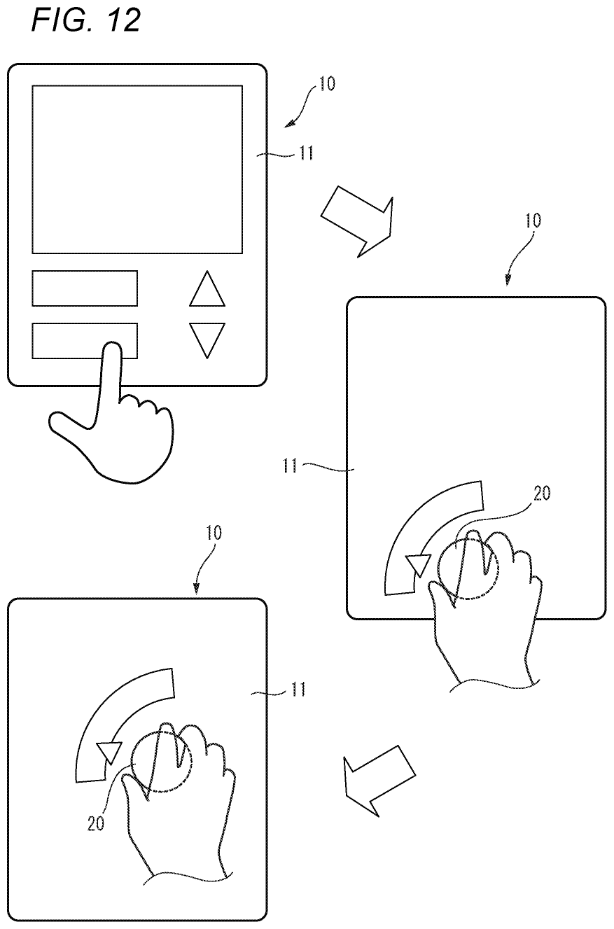

As illustrated in FIG. 12, when the finger F of the user approaches or contacts the detection surface 11, a GUI including an image for accepting a touch operation of the user is displayed on the touch panel 10. Specifically, the processor 132 outputs, from the output interface 133, a first control signal CS1 for causing the touch panel 10 to display the GUI.

When the movable switch 20 is placed on the detection surface 11, a GUI including an image for accepting an instruction input with the movable switch 20 is displayed. Specifically, the processor 132 outputs, from the output interface 133, a second control signal CS2 for causing the touch panel 10 to display the GUI.

In general, a GUI for accepting a user's touch operation has a relatively small area for inputting a specific instruction, and the position of the GUI is strictly determined. On the other hand, as illustrated in this figure, a position where the GUI for accepting an instruction input with the movable switch 20 is displayed can be moved in accordance with the position at which the approach or contact of the second conductive portions 222 to the detection surface 11 is detected.

In other words, the user can perform a desired instruction input by placing the movable switch 20 somewhere in the detection surface 11 and rotating the knob 21. Since the restriction relating to the input position is alleviated as compared with the instruction input with the touch operation, it is possible to improve the operability of the touch panel 10 that is based on the electrostatic capacitance detection system. This advantage is particularly remarkable in a case where the touch panel 10 is installed in the vehicle 1.

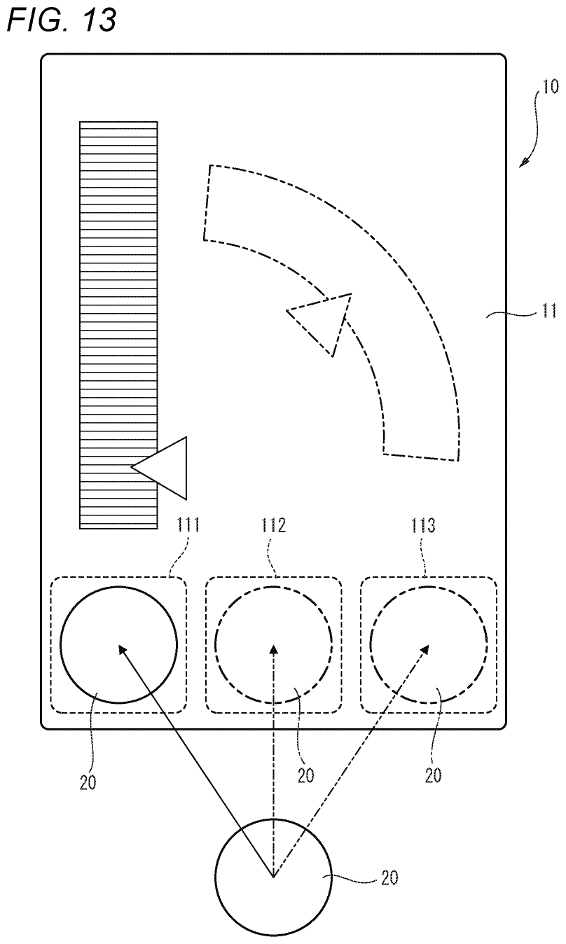

The processor 132 can change the second operation state in accordance with the position in the detection surface 11 of the touch panel 10 where the movable switch 20 (i.e., the second conductive portions 222) is placed. Specifically, as illustrated in FIG. 13, the movable switch 20 may be placed in any of a first area 111, a second area 112, and a third area 113 in the detection surface 11.

For example, when it is detected that the movable switch 20 is placed in the first area 111, the processor 132 may cause the touch panel 10 to display a GUI (illustrated with a solid line) for adjusting the volume of the audio-visual equipment in the vehicle 1. Specifically, the output interface 133 outputs a second control signal CS2 for displaying the GUI.

For example, when it is detected that the movable switch 20 is placed in the second area 112, the processor 132 may cause the touch panel 10 to display a GUI (illustrated with dashed lines) for adjusting the temperature of the air conditioner in the vehicle 1. Specifically, the output interface 133 outputs a second control signal CS2 for displaying the GUI.

For example, when it is detected that the movable switch 20 is placed in the third area 113, the processor 132 may cause the touch panel 10 to display a GUI (not illustrated) for adjusting the air flow of the blower device in the vehicle 1. Specifically, the output interface 133 outputs a second control signal CS2 for displaying the GUI.

According to such a configuration, it is possible to switch functions to be controlled by merely changing the placement position on the detection surface 11 of a single movable switch 20 to which a plurality of functions have been assigned.

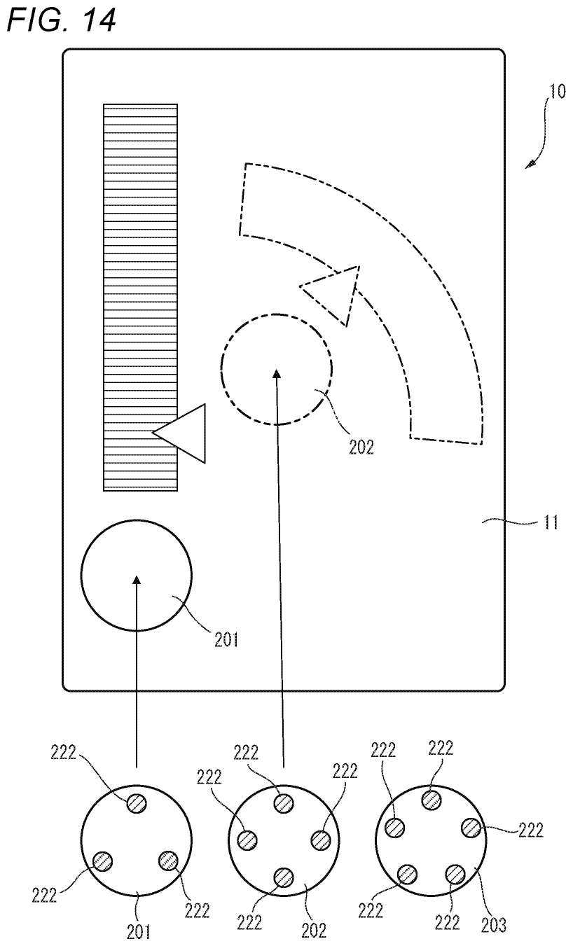

Alternatively, the processor 132 may change the second operation state in accordance with the mutual positional relationship between the second conductive portions 222 to be detected. For example, as illustrated in FIG. 14, a first movable switch 201, a second movable switch 202, and a third movable switch 203 may be provided. The first movable switch 201, the second movable switch 202, and the third movable switch 203 are different from each other in the number and arrangement of the second conductive portions 222. Based on the number and the arrangement of the second conductive portions 222 detected by the touch sensor 12, the processor 132 can determine which movable switch is placed on the detection surface 11.

For example, when it is determined that the first movable switch 201 is placed on the detection surface 11, the processor 132 can cause the touch panel 10 to display a GUI (illustrated with a solid line) for adjusting the volume of the audio-visual equipment in the vehicle 1. Specifically, the output interface 133 outputs a second control signal CS2 for displaying the GUI.

For example, when it is determined that the second movable switch 202 is placed on the detection surface 11, the processor 132 can cause the touch panel 10 to display a GUI (illustrated with dashed lines) for adjusting the temperature of the air conditioner in the vehicle 1. Specifically, the output interface 133 outputs a second control signal CS2 for displaying the GUI.

For example, when it is determined that the third movable switch 203 is placed on the detection surface 11, the processor 132 can cause the touch panel 10 to display a GUI (not illustrated) for adjusting the air flow of the blower device in the vehicle 1. Specifically, the output interface 133 outputs a second control signal CS2 for displaying the GUI.

According to such a configuration, it is possible to switch functions to be controlled by merely placing any one of the movable switches that are different in the mutual positional relationship of the second conductive portions 222, while being free from the restriction as to the placement position in the detection surface 11.

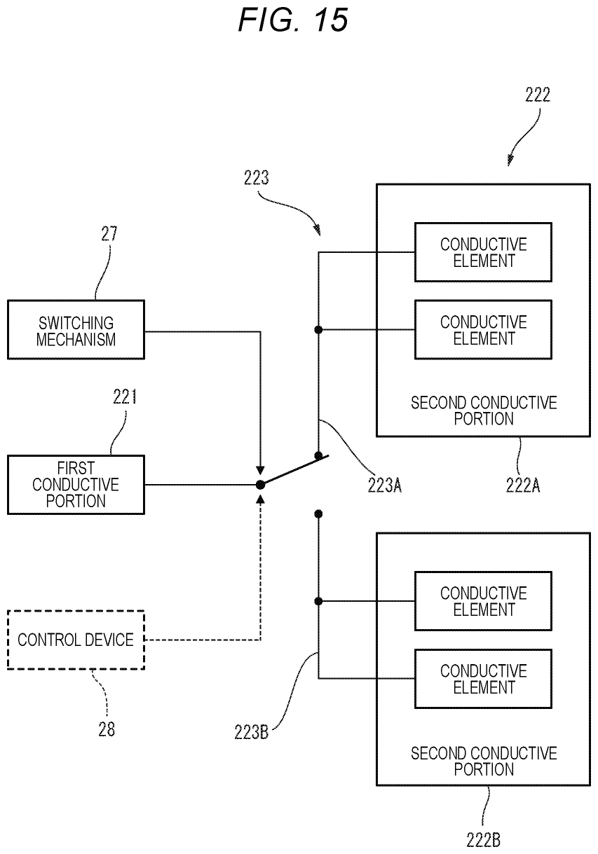

According to the configuration illustrated in FIG. 15, it is possible to realize a state in which the mutual positional relationships of the second conductive portions 222 are different from each other while using a single movable switch 20. In this example, the second conductive portions 222 include a plurality of groups 222A and 222B each including a plurality of conductive elements. In this case, the conductive path 223 includes a plurality of conductive path elements 223A and 223B for electrically connecting the first conductive portion 221 to a plurality of conductive elements included in any one of the groups 222A and 222B.

The movable switch 20 may be equipped with a switching mechanism 27. The switching mechanism 27 is configured to select one of the conductive path elements 223A and 223B based on a mechanical operation performed by a user. For example, the switching mechanism 27 may be configured to alternately select the conductive path element 223A and the conductive path element 223B each time the push operation of the knob 21 is performed. In other words, each time the push operation of the knob 21 is performed, the conductive elements included in the group 222A and the conductive elements included in the group 222B are alternately subjected to electrical connection with the first conductive portion 221.

Alternatively, the movable switch 20 may be equipped with a control device 28. The control device 28 is configured to recognize a voice of the user, and to select one of the conductive path elements 223A and 223B based on the voice.

For example, the conductive elements included in the group 222A may be associated with a volume adjustment function of the audio-visual equipment in the vehicle 1. The conductive elements included in the group 222B may be associated with a function of adjusting the temperature of the air conditioner in the vehicle 1. In this case, when the user inputs a sound suggesting the volume adjustment (“sound”, “volume” or the like) with respect to the movable switch 20, the control device 28 selects the conductive path element 223A. As a result, the first conductive portion 221 and the conductive elements included in the group 222A are electrically connected to each other. When the user inputs a sound indicating the temperature adjustment (“temperature”, “heating”, “cooling”, or the like) with respect to the movable switch 20, the control device 28 selects the conductive path element 223B. As a result, the first conductive portion 221 and the conductive elements included in the group 222B are electrically connected to each other.

The control device 28 can be realized by an exclusive integrated circuit such as a microcontroller, an ASIC, and an FPGA capable of executing a computer program for realizing such a function.

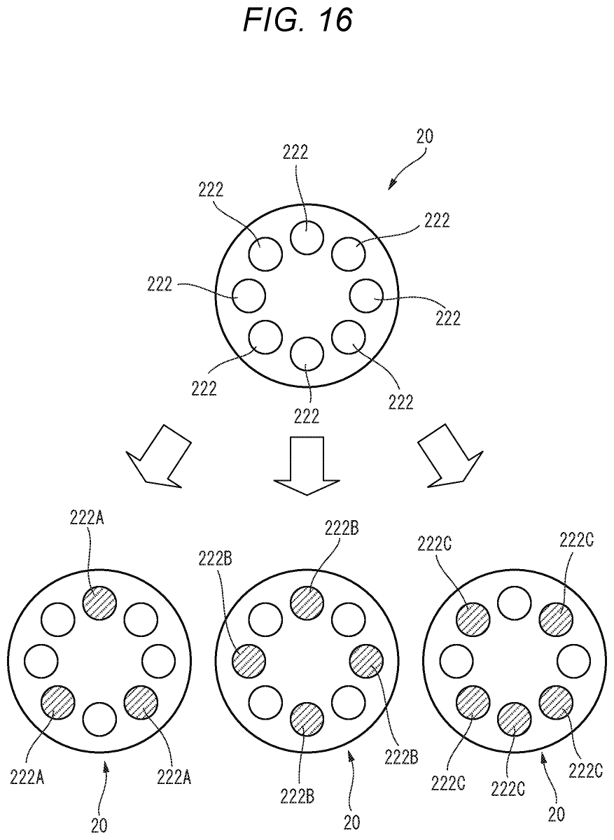

In FIG. 15, the conductive elements included in each of the groups 222A and 222B are independent of each other. However, the groups may share the same conductive element. Such a specific example will be described with reference to FIG. 16.

Eight second conductive portions 222 (conductive elements) are disposed on a bottom face of the movable switch 20 illustrated in FIG. 16. In this figure, the hatched second conductive portion 222 indicates a state where it is electrically connected to the first conductive portion 221. In this example, the eight second conductive portions 222 include a plurality of groups 222A, 222B, and 222 C. Each group includes a plurality of second conductive portions 222 (conductive elements). The number and mutual positional relationship of the second conductive portions 222 (conductive elements) included in each group are different from those in another group, but a part of the second conductive portions 222 (conductive elements) are shared by a plurality of groups. Any one of the groups 222A, 222B, and 222 C can be selected by the switching mechanism 27 or the control device 28 described above.

According to such a configuration, a plurality of functions can be assigned to a single movable switch 20. It is possible to switch functions to be controlled by selecting the second conductive portions 222 to be electrically connected to the first conductive portion 221, while being free from the restriction as to the placement position in the detection surface 11.

The processor 132 having various functions described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of a non-transitory computer-readable medium having stored a computer program. The general-purpose microprocessor designates at least a part of the program stored in the ROM, loads the program on the RAM, and executes the processing described above in cooperation with the RAM. The above-described computer program may be pre-installed in a general-purpose memory, or may be downloaded from an external server via a communication network (not illustrated) and then installed in the general-purpose memory. In this case, the external server is an example of the non-transitory computer-readable medium having stored a computer program.

The processor 132 may be implemented by an exclusive integrated circuit such as a microcontroller, an ASIC, and an FPGA capable of executing the above-described computer program. In this case, the above-described computer program is pre-installed in a memory element included in the exclusive integrated circuit. The memory element is an example of a non-transitory computer-readable medium having stored a computer program. The processor 132 may be implemented by a combination of the general-purpose microprocessor and the exclusive integrated circuit.

The above embodiments are merely illustrative for facilitating understanding of the gist of the presently disclosed subject matter. The configuration according to the above embodiment can be appropriately modified or improved without departing from the gist of the presently disclosed subject matter.

In the above embodiment, the movable switch 20 is entirely placed on the detection surface 11 of the touch panel 10. However, as long as an instruction can be inputted by way of the displacement of the second conductive portions 222, it is possible to employ a configuration wherein just a part of the movable switch 20 is placed on the detection surface 11.

In the above embodiment, the second conductive portions 222 face the detection surface 11 of the touch panel 10 with a gap interposed therebetween. However, the second conductive portions 222 may be in contact with the detection surface 11 at least one of when the knob 21 is at rest and when the knob 21 is moved.

The movable switch 20 is not limited to a dial switch. As long as the movable part capable of displacing the second conductive portions 222 with respect to the detection surface 11 of the touch panel 10 is provided, a form such as a lever switch or a slide switch may be employed.

The touch operation detected by the detection surface 11 of the touch panel 10 is not necessarily performed with the finger F of the user. A touch operation performed with a body part such as a palm, an elbow, a knee, and a toe can also be detected.

The mobile entity in which the touch panel 10 and the movable switch 20 are installed is not limited to the vehicle 1. Examples of other mobile entities include railways, ships, and aircrafts. The mobile entity may not require a driver.

The touch panel 10 and the movable switch 20 can be used in an appropriate user interface that requires detection of a touch operation by a user. Examples of the device equipped with such a user interface include an air conditioner of a building, a dimmer of a building, an audio-visual equipment, a cooking device, an air conditioner, a game device, a toy, and the like that can be used indoors or outdoors.

The present application is based on Japanese Patent Application No. 2019-203270 filed on Nov. 8, 2019, the entire contents of which are incorporated herein by reference.

1. An instruction input device at least a part of which is adapted to be placed on a detection surface that is capable of detecting a variation in electrostatic capacitance caused by an approach or contact of a user's body, comprising:
a movable part configured to be displaced relative to the detection surface in accordance with an operation of a part of the user's body;
a first conductive portion arranged at a position in the movable part where is separated from the detection surface;
a plurality of second conductive portions arranged at positions in the movable part where are closer to the detection surface than the first conductive portion;
a conductive path electrically connecting the first conductive portion and the second conductive portions.

2. The instruction input device according to claim 1,
wherein the second conductive portions face the detection surface with a gap interposed therebetween when the movable part is displaced.

3. The instruction input device according to claim 1, further comprising:
a fixing part adapted to be fixed on the detection surface while allowing displacement of the movable part.

4. The instruction input device according to claim 1, being detachable from the detection surface.

5. The instruction input device according to claim 1,
wherein the second conductive portions include a plurality of groups each including a plurality of conductive elements;
wherein the conductive path includes a plurality of conductive path elements configured to electrically connect the first conductive portion with the conductive elements included in any one of the groups; and
wherein the instruction input device further comprises a switching mechanism configured to select one of the conductive elements in accordance with a mechanical operation of the user.

6. The instruction input device according to claim 1,
wherein the second conductive portions include a plurality of groups each including a plurality of conductive elements;
wherein the conductive path includes a plurality of conductive path elements configured to electrically connect the first conductive portion with the conductive elements included in any one of the groups; and
wherein the instruction input device further comprises a control device configured to recognize a voice of the user and to select one of the conductive elements in accordance with the voice.

7. The instruction input device according to claim 1,
wherein the detection surface is installed in a mobile entity.
